(19) United States
(12) Patent Application Publication
(10) Pub. No.: US 2024/0311242 A1
(43) Pub. Date: Sep. 19, 2024

(54) DEVICE RECOVERY USING SELECTION OF AN ALTERNATE BIOS

(71) Applicant: Dell Products L.P., Round Rock, TX (US)

(72) Inventors: Tomer Shachar, Beer Sheva (IL); Ophir Buchman, Raanana (IL); Yevgeni Gehtman, Modi'in (IL)

(21) Appl. No.: 18/122,996

(22) Filed: Mar. 17, 2023

(51) Int. Cl. G06F 11/14; G06F 11/20; G06F 13/40

(52) U.S. Cl. CPC G06F 11/1417; G06F 11/2028; G06F 13/4068

(57) ABSTRACT

Techniques are provided for device recovery using selection of an alternate basic input/output system (BIOS). One method comprises obtaining, in response to an application of power to a processing device, instructions provided by a selected BIOS chip of multiple BIOS chips of the processing device, wherein the selected BIOS chip is selected using a selector switch that provides a connection between the selected BIOS chip and an additional component; and executing, by the processing device, at least one of the instructions to initiate a boot process of the processing device. The selector switch may select only one of the BIOS chips at a given time. The selector switch may comprise portions of electrical paths between the selected BIOS chip and the additional component and may provide power to the selected BIOS chip. The selector switch may be controlled by a user to select one of the BIOS chips.

### FIELD

The field relates generally to information processing systems, and more particularly to the protection of devices in such information processing systems.

### BACKGROUND

Computing devices are typically configured to incorporate security functionality to protect such devices from malicious activity. For example, it is generally desirable to prevent suspicious computer operations, and to ensure that operations are implemented by legitimate and authorized users. Role-based access control (RBAC) techniques may be employed to restrict access to devices or network resources based on the roles of individual users within an organization. RBAC techniques typically allow users to access only the information and other resources needed for their jobs and prevent users from accessing additional resources. RBAC techniques, however, are vulnerable to various types of attacks, such as password theft and/or session hijacking.

A need exists for improved techniques for protecting devices from suspicious and/or unauthorized computer operations.

### SUMMARY

In one embodiment, a method comprises obtaining, by at least one processing device, in response to an application of power to the at least one processing device, one or more instructions provided by a selected basic input/output system (BIOS) chip of a plurality of BIOS chips of the at least one processing device, wherein the selected BIOS chip is selected using a selector switch that provides a connection between the selected BIOS chip and one or more additional components; and executing, by the at least one processing device, at least one of the one or more instructions to initiate a boot process of the at least one processing device.

In some embodiments, the selector switch selects only one of the plurality of BIOS chips at a given time. The selector switch may comprise at least portions of each of a plurality of electrical paths between the selected BIOS chip and the one or more additional components. The plurality of electrical paths may comprise at least portions of each of at least a receive path, a transmit path and a power path. The selector switch may be controlled by a user to select one of the plurality of BIOS chips.

In one or more embodiments, the plurality of BIOS chips comprises at least a primary BIOS chip and at least one secondary BIOS chip, and wherein, in response to one or more of a failure of the selected BIOS chip, a degradation of the selected BIOS chip and a detection of unauthorized software on the at least one processing device, the selector switch is controlled to select one of the at least one secondary BIOS chip. The selected at least one secondary BIOS chip may load an operating system associated with the at least one processing device following the one or more of the failure, the degradation and the detection of the unauthorized software.

Other illustrative embodiments include, without limitation, apparatus, systems, methods and computer program products comprising processor-readable storage media.

### BRIEF DESCRIPTION OF THE DRAWINGS

FIG. 1 illustrates an information processing system configured for device recovery using selection of an alternate BIOS in accordance with an illustrative embodiment;

FIG. 2 illustrates the protected hardware device of FIG. 1 in further detail in accordance with an illustrative embodiment;

FIG. 3 illustrates a motherboard of a protected hardware device configured to employ alternate BIOS selection in accordance with an illustrative embodiment;

FIGS. 4 and 5 illustrate an exemplary implementation of a motherboard configured to select a first BIOS chip and a second BIOS chip, respectively, in accordance with illustrative embodiments;

FIGS. 6 and 7 are flow charts illustrating exemplary implementations of processes for device recovery using selection of an alternate BIOS in accordance with illustrative embodiments;

FIG. 8 illustrates an exemplary processing platform that may be used to implement at least a portion of one or more embodiments of the disclosure comprising a cloud infrastructure; and

FIG. 9 illustrates another exemplary processing platform that may be used to implement at least a portion of one or more embodiments of the disclosure.

### DETAILED DESCRIPTION

Illustrative embodiments of the present disclosure will be described herein with reference to exemplary communication, storage and processing devices. It is to be appreciated, however, that the disclosure is not restricted to use with the particular illustrative configurations shown. One or more embodiments of the disclosure provide methods, apparatus and computer program products for device recovery using selection of an alternate BIOS.

The BIOS of a given device initializes hardware components of the given device during a boot process and allows the hardware components to properly communicate and work together during device startup. One or more aspects of the disclosure recognize that malicious or unauthorized modifications of a BIOS chip or metadata associated with the BIOS chip may cause a denial of service or permit an unauthorized operating system to be loaded (sometimes referred to as a backdoor attack that may cause unpredictable damage). A BIOS chip is thus important for the proper operation of a given device, and if the BIOS chip is corrupted or damaged, the given device will typically be unable to start up. In addition, a recovery of the BIOS when the BIOS chip is corrupted or damaged is typically complex, costly, and may require a hardware replacement.

In one or more embodiments, techniques are provided for device recovery using selection of an alternate BIOS. In some embodiments, a BIOS selector switch is provided that can be positioned (e.g., manually positioned) to select a particular one of a plurality of available BIOS chips to be active (e.g., when the device starts up or otherwise undergoes a boot process). The selected BIOS chip executes the BIOS to initialize the startup process of a protected hardware device. For example, following a BIOS failure, a BIOS degradation and/or a detection of unauthorized software, the BIOS selector switch may be employed to select an alternate BIOS chip.

In some embodiments, the disclosed alternate BIOS selection techniques can be employed to protect a given device, for example, following a failure, a degradation and/or a detection of unauthorized software that impacts the operation of the active BIOS chip. The BIOS selector switch can be repositioned (e.g., manually repositioned) to select an alternate BIOS chip to be active during the boot process that will allow the operating system of the given device to load.

Among other benefits, the disclosed alternate BIOS selection techniques protect devices from unauthorized, erroneous and/or malicious actions that may impair the operation of a BIOS chip of a given device. Such actions can be detected and overcome using the disclosed alternate BIOS selection techniques.

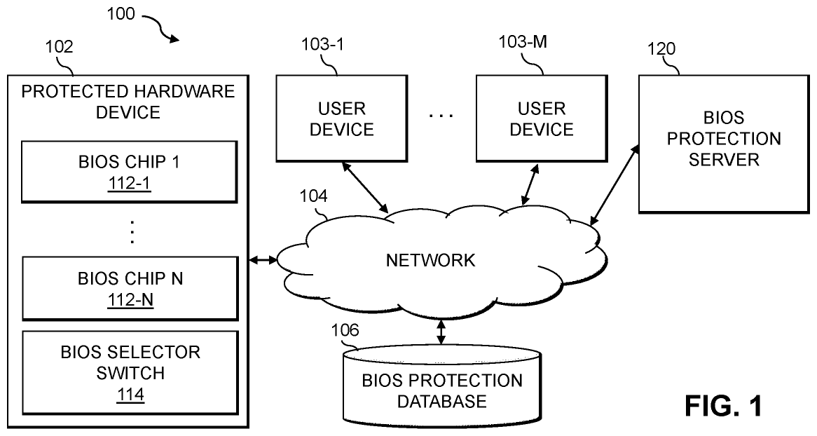

FIG. 1 shows a computer network (also referred to herein as an information processing system) 100 configured in accordance with an illustrative embodiment. The computer network 100 comprises a plurality of user devices 103-1 through 103-M, collectively referred to herein as user devices 103. The user devices 103 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is one or more protected hardware devices 102, one or more BIOS protection servers 120 and one or more BIOS protection databases 106, discussed below.

The protected hardware devices 102 may comprise edge devices, host devices and other devices that execute user commands. One or more aspects of the disclosure recognize that edge devices, for example, are attractive targets for an attack and often comprise critical infrastructure that may require an evaluation of whether to execute certain commands and/or operations and/or whether the BIOS has been altered. Edge devices may be stored, for example, in a physical location that may not be properly secured. An attacker may be able to access a perimeter of a location of the edge device (or another adjacent or nearby location that is within range of the edge device).

The user devices 103 may comprise, for example, host devices and/or devices such as mobile telephones, laptop computers, tablet computers, desktop computers or other types of computing devices. Such devices are examples of what are more generally referred to herein as “processing devices” which may be protected using the disclosed device protection techniques. Some of these processing devices are also generally referred to herein as “computers.” The user devices 103 may comprise a network client that includes networking capabilities such as ethernet, Wi-Fi, etc. When the user devices 103 are implemented as host devices, the host devices may illustratively comprise servers or other types of computers of an enterprise computer system, cloud-based computer system or other arrangement of multiple compute nodes associated with respective users.

For example, the host devices in some embodiments illustratively provide compute services such as execution of one or more applications on behalf of each of one or more users associated with respective ones of the host devices.

The user devices 103 in some embodiments comprise respective processing devices associated with a particular company, organization or other enterprise or group of users. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

It is to be appreciated that the term “user” in this context and elsewhere herein is intended to be broadly construed so as to encompass, for example, human, hardware, software or firmware entities (including services), as well as various combinations of such entities. Compute and/or storage services may be provided for users under a Platform-as-a-Service (PaaS) model, a Storage-as-a-Service (STaaS) model, an Infrastructure-as-a-Service (IaaS) model and/or a Function-as-a-Service (FaaS) model, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

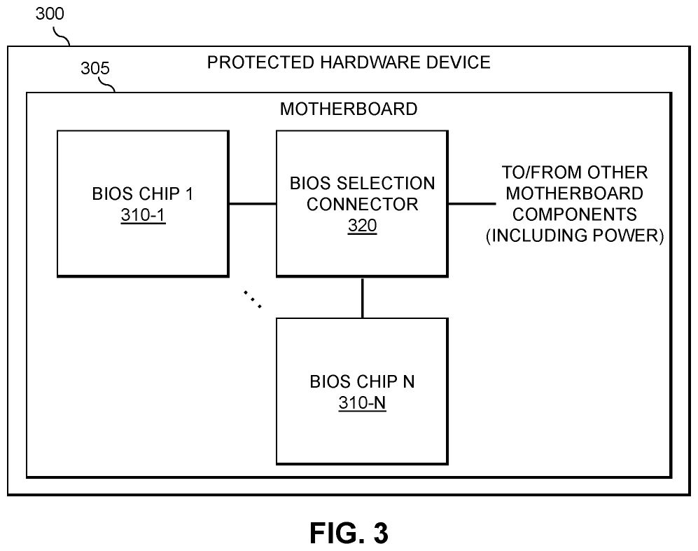

As shown in FIG. 1, an exemplary protected hardware device 102 may comprise a plurality of BIOS chips 112-1 through 112-N, collectively referred to herein as BIOS chips 112, and a BIOS selector switch 114. The BIOS selector switch 114 is a selector switch that can be positioned to select a particular one of the BIOS chips 112 to be active, as discussed further below in conjunction with FIGS. 3 through 5, for example. The selected BIOS chip 112 executes the BIOS to initialize the startup process of the exemplary protected hardware device 102 (e.g., when the exemplary protected hardware device 102 starts up).

In some embodiments, the BIOS chips 112 are on a motherboard of the exemplary protected hardware device 102 and are substantially identical in terms of functionality and provide redundancy. In at least one embodiment, at least one of the BIOS chips 112 employs a one-way diode or other immutable functionality (e.g., a read-only mechanism) to protect the at least one BIOS chip 112 (e.g., a receive path of the at least one BIOS chip 112 is not active, is not present or comprises a one-way diode or other functionality to ensure that the at least one BIOS chip 112 may not be modified).

It is to be appreciated that this particular arrangement of elements 112, 114 illustrated in the protected hardware device 102 of the FIG. 1 embodiment is presented by way of example only, and alternative arrangements can be used in other embodiments. For example, the functionality associated with elements 112, 114 in other embodiments can be combined into a single element, or separated across a larger number of elements. As another example, multiple distinct processors can be used to implement different ones of elements 112, 114, or portions thereof.

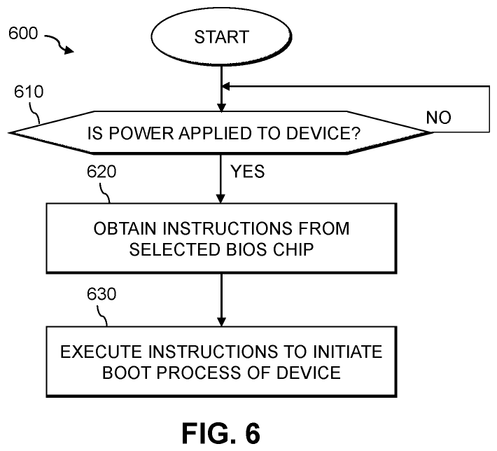

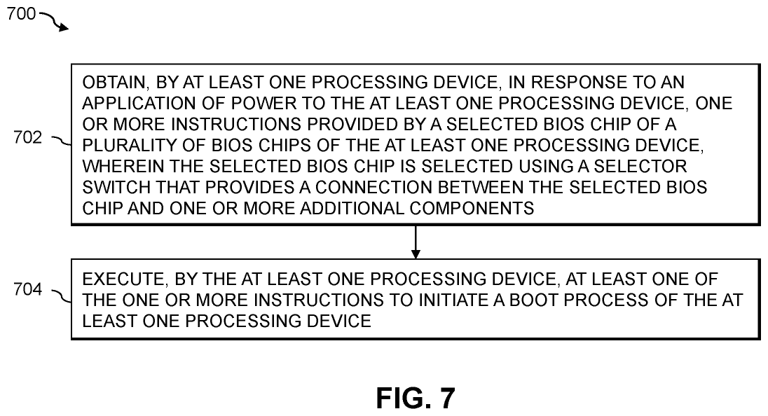

At least portions of elements 112, 114 may be implemented at least in part in the form of software that is stored in memory and executed by a processor. An exemplary process utilizing elements 112, 114 of the protected hardware device 102 in computer network 100 will be described in more detail with reference to FIGS. 6 and 7, for example.

Other protected hardware devices 102 (not shown in FIG. 1) are assumed to be configured in a manner similar to that shown for protected hardware device 102 in the figure.

The BIOS protection server 120 may be implemented, for example, on the cloud, such as a private cloud, or on the premises of an enterprise or another entity. In some embodiments, the BIOS protection server 120, or portions thereof, may be implemented as part of a host device. The BIOS protection server 120 may implement server-side functionality associated with the disclosed alternate BIOS selection techniques, such as, for example, implementing performance monitoring and policies for redundancy requirements for BIOS chips.

Additionally, the protected hardware device 102 and/or the BIOS protection server 120 can have an associated BIOS protection database 106 configured to store, for example, a set of policies for BIOS redundancy and/or information related to various devices, such as one or more protected hardware devices 102, such as device locations, network address assignments and performance data. The BIOS protection database 106 may be maintained, for example, by the BIOS protection server 120 and accessible by one or more protected hardware devices 102.

The BIOS protection database 106 in the present embodiment is implemented using one or more storage systems associated with the BIOS protection server 120. Such storage systems can comprise any of a variety of different types of storage such as, network-attached storage (NAS), storage area networks (SANs), direct-attached storage (DAS) and distributed DAS, as well as combinations of these and other storage types, including software-defined storage.

The one or more protected hardware devices 102, user devices 103 and/or BIOS protection servers 120 may be implemented on a common processing platform, or on separate processing platforms. The one or more protected hardware devices 102 and user devices 103 may be configured to interact over the network 104 in at least some embodiments with the BIOS protection server 120.

The term “processing platform” as used herein is intended to be broadly construed so as to encompass, by way of illustration and without limitation, multiple sets of processing devices and associated storage systems that are configured to communicate over one or more networks. For example, distributed implementations of the system 100 are possible, in which certain components of the system reside in one data center in a first geographic location while other components of the system reside in one or more other data centers in one or more other geographic locations that are potentially remote from the first geographic location. Thus, it is possible in some implementations of the system 100 for the user devices 103 and the storage system to reside in different data centers. Numerous other distributed implementations of the host devices and the storage system are possible.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the one or more protected hardware devices 102, user devices 103 and/or BIOS protection servers 120 can be one or more input-output devices (not shown), which illustratively comprise keyboards, displays or other types of input-output devices in any combination. Such input-output devices can be used, for example, to support one or more user interfaces to the BIOS protection server 120, as well as to support communication between the BIOS protection server 120 and other related systems and devices not explicitly shown.

The one or more protected hardware devices 102, user devices 103 and/or BIOS protection servers 120 in the FIG. 1 embodiment are assumed to be implemented using at least one processing device. Each such processing device generally comprises at least one processor and an associated memory and implements one or more functional modules for controlling certain features of the respective device.

More particularly, the one or more protected hardware devices 102, user devices 103 and/or BIOS protection servers 120 in this embodiment each can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including SSDs, and should therefore not be viewed as limited in any way to spinning magnetic media.

The network interface allows the one or more protected hardware devices 102, user devices 103 and/or BIOS protection servers 120 to communicate in some embodiments over the network 104 with each other (as well as one or more other networked devices), and illustratively comprises one or more conventional transceivers.

It is to be understood that the particular set of elements shown in FIG. 1 for device recovery using selection of an alternate BIOS is presented by way of illustrative example only, and in other embodiments additional or alternative elements may be used. Thus, another embodiment includes additional or alternative systems, devices and other network entities, as well as different arrangements of modules and other components.

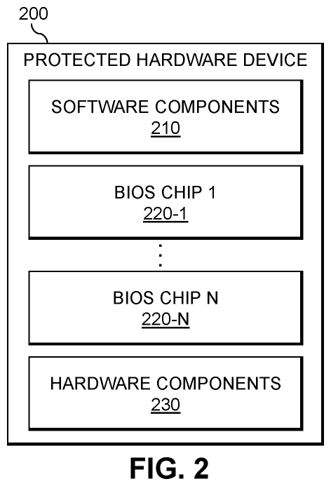

FIG. 2 illustrates a protected hardware device 200 in accordance with an illustrative embodiment. In the example of FIG. 2, the protected hardware device 200 comprises one or more software components 210, a plurality of BIOS chips 220-1 through 220-N, and one or more hardware components 230. The BIOS chips 220 may be implemented, for example, as a BIOS (Basic Input Output System) chip, an Extensible Firmware Interface (EFI) BIOS chip, and/or a Unified Extensible Firmware Interface (UEFI) BIOS chip. It is noted that multiple BIOS chips 220 can be present on a given protected hardware device 200. The BIOS chips 220 typically initialize hardware during a boot process for a given device. A malicious modification of the BIOS or metadata associated with the BIOS can cause a denial of service or permit an unauthorized operating system to be loaded (sometimes referred to as a backdoor attack that may cause unpredictable damage).

A kernel (e.g., resident in the memory of the protected hardware device 200) may provide an interface between the software components 210 and the hardware components 230. The term kernel, as used herein, encompasses any computer program that is part of an operating system of a protected hardware device 200 that enables interactions between such software components 210, such as applications, and the hardware components 230 of the protected hardware device 200. The hardware components 230 may comprise, for example, processing components, memory components, storage components and other hardware components.

FIG. 3 illustrates a motherboard 305 of a protected hardware device 300 configured to employ alternate BIOS selection in accordance with an illustrative embodiment. In the example of FIG. 3, the motherboard 305 comprises a BIOS selection connector 320 that selects one of a plurality of BIOS chips 310-1 through 310-N (collectively, referred to as BIOS chips 310). The BIOS chips 310 may comprise, for example, a primary BIOS chip and one or more secondary (e.g., backup) BIOS chips. The BIOS chips 310 may each be implemented, for example, as an EFI BIOS chip, and/or a UEFI BIOS chip. The multiple BIOS chips 310, in some embodiments, may be identical in terms of hardware, provide substantially similar functionality and may have different versions of firmware.

In one or more embodiments, the BIOS selection connector 320 may comprise a physical switch between the multiple BIOS chips 310 and one or more additional components of the motherboard 305. A user may position the BIOS selection connector 320 to select the selected BIOS chip 310 (for example, by opening a device chassis to operate and reposition the selected switch position of the BIOS selection connector 320). The user may select an alternate BIOS chip 310 following, for example, a failure, a degradation and/or a detection of malware or other unauthorized software associated with a current primary BIOS chip 310. For example, a user may observe that an operating system of a device comprising the motherboard 305 cannot load or may be notified of a BIOS problem (e.g., by means of a warning and/or error message) and then initiate the selection (e.g., a manual selection) of a different BIOS chip 310 using the BIOS selection connector 320.

In at least some embodiments, the BIOS selection connector 320 selects only one of the BIOS chips 310 at a given time. In addition, the BIOS selection connector 320 may provide power (e.g., a voltage) to only the selected BIOS chip. In this manner, only one BIOS chip may be active at a given time. The BIOS selection connector 320 may connect a plurality of electrical paths between the single selected BIOS chip and one or more additional components of the motherboard 305 (not shown in FIG. 3).

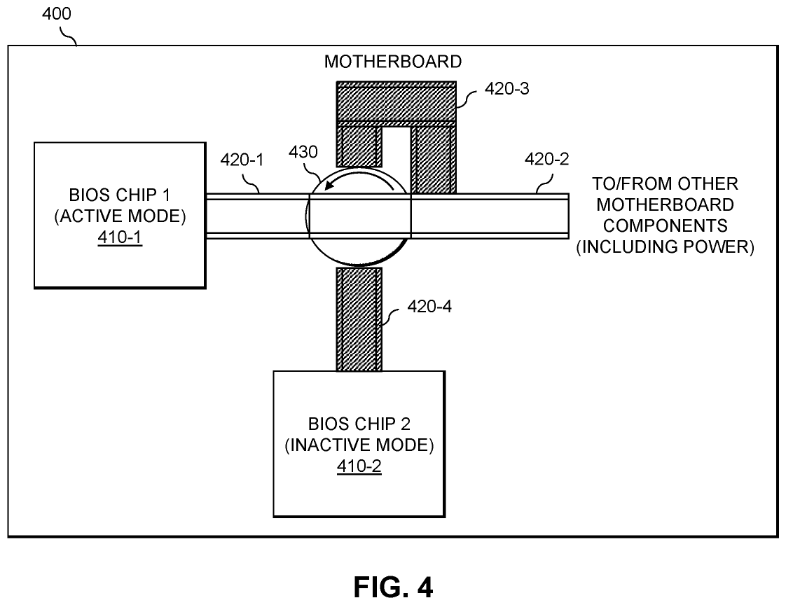

FIG. 4 illustrates an exemplary implementation of a motherboard 400 configured to select a first BIOS chip 410-1, in accordance with an illustrative embodiment. In the example of FIG. 4, the motherboard 400 comprises a BIOS selection connector 430 that selects one of a first BIOS chip 410-1 and a second BIOS chip 410-2. The BIOS chips 410 may comprise, for example, a primary BIOS chip and one or more secondary (e.g., backup) BIOS chips. In some embodiments, the BIOS selection connector 430 may select a BIOS chip 410 designated as a primary BIOS chip by default, and may be rotated, for example, by a user to select an alternate BIOS chip 410, as needed. The BIOS chips 410 may each be implemented, for example, as an EFI BIOS chip, and/or a UEFI BIOS chip.

As shown in FIG. 4, the selected first BIOS chip 410-1 is in an active mode (e.g., selected) and will receive power and be active during a boot process to initialize hardware of a device comprising the motherboard 400. Likewise, the second BIOS chip 410-2 is in an inactive mode (e.g., unselected) and will not receive power or be active during a boot process to initialize hardware of a device comprising the motherboard 400.

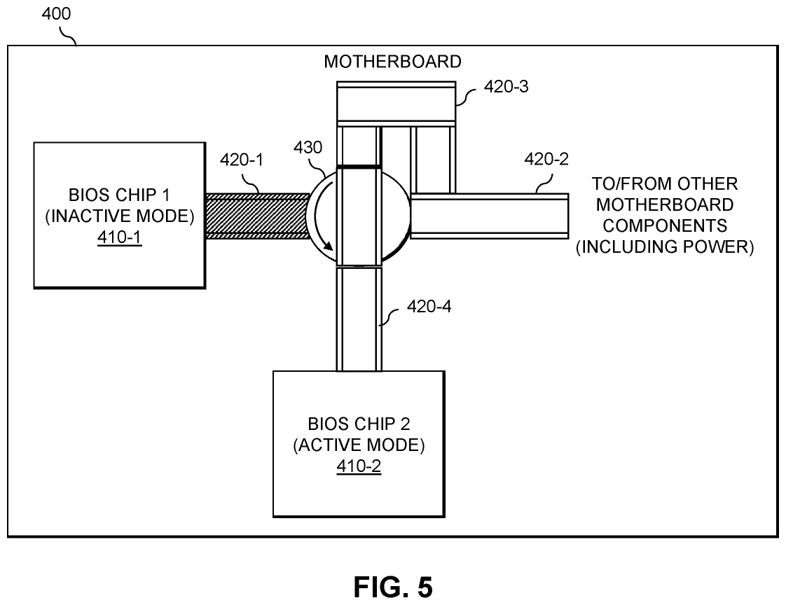

The BIOS selection connector 430 connects a plurality of electrical paths between the single selected BIOS chip and one or more additional components of the motherboard 400 (not shown in FIG. 4). The electrical paths may comprise, for example, receive, transmit and power paths. When the first BIOS chip 410-1 is selected, for example, as shown in FIG. 4, the BIOS selection connector 430 connects metal bridge segment 420-1 (comprising active electrical paths) with metal bridge segment 420-2 comprising additional electrical paths to the one or more additional components of the motherboard 400. Metal bridge segments 420-3 and 420-4 comprising additional inactive electrical paths associated with the second (inactive) BIOS chip 410-2 are shown in FIG. 4 with a hashed formatting and are discussed further below in conjunction with FIG. 5.

FIG. 5 illustrates an exemplary implementation of the motherboard 400 of FIG. 4 configured to select a second BIOS chip, in accordance with an illustrative embodiment. In the example of FIG. 5, the motherboard 400 comprises the BIOS selection connector 430 that selects one of the first BIOS chip 410-1 and the second BIOS chip 410-2 of FIG. 4.

In the example of FIG. 5, the BIOS selection connector 430 has been rotated 90 degrees (relative to the position of the BIOS selection connector 430 in FIG. 4) to select the second BIOS chip 410-2. The selected second BIOS chip 410-2 is in an active mode (e.g., selected) and will receive power and be active during a boot process to initialize hardware of a device comprising the motherboard 400. Likewise, the first BIOS chip 410-1 is in an inactive mode (e.g., unselected) and will not receive power or be active during a boot process to initialize hardware of a device comprising the motherboard 400.

As noted above, the BIOS selection connector 430 connects a plurality of electrical paths between the single selected BIOS chip and one or more additional components of the motherboard 400 (not shown in FIG. 5). For example, when the second BIOS chip 410-2 is selected, as shown in FIG. 5, the BIOS selection connector 430 connects metal bridge segment 420-4 comprising active electrical paths with metal bridge segment 420-3 comprising additional active electrical paths, which, in turn are connected to metal bridge segment 420-2 and the one or more additional components of the motherboard 400. Metal bridge segment 420-1, comprising additional inactive electrical paths associated with the first (inactive) BIOS chip 410-1, is shown in FIG. 5 with a hashed formatting.

In some embodiments, the electrical paths of the metal bridge segment 420-4 associated with the second BIOS chip 410-2 comprise one or more one-way diodes to provide additional protection for the second BIOS chip 410-2. In another embodiment, the electrical paths associated with the metal bridge segment 420-4 may comprise only transmit and power paths (e.g., the receive path is not active and/or not present) or another mechanism for ensuring immutability.

FIG. 6 is a flow chart illustrating an exemplary implementation of a process 600 for device recovery using selection of an alternate BIOS in accordance with an illustrative embodiment. In the example of FIG. 6, the process 600 initially performs a test in step 610 to determine if power is applied to a given device. If it is determined in step 610 that power is not applied to the given device, then program control returns to step 610 until power is applied to the given device.

If it is determined in step 610 that power is applied to the given device, then the process 600 obtains one or more instructions from the selected BIOS chip in step 620 and executes at least some of the one or more instructions from the selected BIOS chip in step 630 to initiate a boot process of the given device.

FIG. 7 is a flow chart illustrating an exemplary implementation of a process 700 for device recovery using selection of an alternate BIOS in accordance with an illustrative embodiment. In the example of FIG. 7, the process 700 obtains, in step 702, by at least one processing device, in response to an application of power to the at least one processing device, one or more instructions provided by a selected BIOS chip of a plurality of BIOS chips of the at least one processing device, wherein the selected BIOS chip is selected using a selector switch that provides a connection between the selected BIOS chip and one or more additional components. As used herein, the phrase “application of power” shall be broadly construed to encompass any activity that results in power being applied to the at least one processing device, such as a user pressing a power button, or another similar activation, or a user initiating a reboot of the at least one processing device.

In step 704, the process 700 executes, by the at least one processing device, at least one of the one or more instructions to initiate a boot process of the at least one processing device.

In some embodiments, the selector switch selects only one of the plurality of BIOS chips at a given time. The selector switch may comprise at least portions of each of a plurality of electrical paths between the selected BIOS chip and the one or more additional components. The plurality of electrical paths may comprise at least portions of each of at least a receive path, a transmit path and a power path. The selector switch may be controlled by a user to select one of the plurality of BIOS chips.

In one or more embodiments, the plurality of BIOS chips comprises at least a primary BIOS chip and at least one secondary BIOS chip, and wherein, in response to one or more of a failure of the selected BIOS chip, a degradation of the selected BIOS chip and a detection of unauthorized software on the at least one processing device, the selector switch is controlled to select one of the at least one secondary BIOS chip. The selected at least one secondary BIOS chip may load an operating system associated with the at least one processing device following the one or more of the failure, the degradation and the detection of the unauthorized software.

The particular processing operations and other network functionality described in conjunction with FIGS. 6 and 7, for example, are presented by way of illustrative example only, and should not be construed as limiting the scope of the disclosure in any way. Alternative embodiments can use other types of processing operations for device recovery using selection of an alternate BIOS. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

The disclosed techniques for device recovery using selection of an alternate BIOS can be employed, for example, to protect a given device, for example, following a failure, a degradation and/or a detection of unauthorized software that impacts the active BIOS chip. The provided BIOS selector switch can be repositioned (e.g., manually repositioned) to select an alternate BIOS chip to be active during the boot process and thereby allow the operating system of the given device to load. In this manner, the disclosed alternate BIOS selection techniques protect devices from unauthorized, erroneous and/or malicious actions that may impair the operation of a BIOS chip of a given device. Such actions can be detected and overcome using the disclosed alternate BIOS selection techniques.

One or more embodiments of the disclosure provide improved methods, apparatus and computer program products for device recovery using selection of an alternate BIOS. The foregoing applications and associated embodiments should be considered as illustrative only, and numerous other embodiments can be configured using the techniques disclosed herein, in a wide variety of different applications.

It should also be understood that the disclosed alternate BIOS selection techniques, as described herein, can be implemented at least in part in the form of one or more software programs stored in memory and executed by a processor of a processing device such as a computer. As mentioned previously, a memory or other storage device having such program code embodied therein is an example of what is more generally referred to herein as a “computer program product.”

The disclosed techniques for device recovery using selection of an alternate BIOS may be implemented using one or more processing platforms. One or more of the processing modules or other components may therefore each run on a computer, storage device or other processing platform element. A given such element may be viewed as an example of what is more generally referred to herein as a “processing device.”

As noted above, illustrative embodiments disclosed herein can provide a number of significant advantages relative to conventional arrangements. It is to be appreciated that the particular advantages described above and elsewhere herein are associated with particular illustrative embodiments and need not be present in other embodiments. Also, the particular types of information processing system features and functionality as illustrated and described herein are exemplary only, and numerous other arrangements may be used in other embodiments.

In these and other embodiments, compute services can be offered to cloud infrastructure tenants or other system users as a PaaS offering, although numerous alternative arrangements are possible.

Some illustrative embodiments of a processing platform that may be used to implement at least a portion of an information processing system comprise cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components such as a cloud-based alternate BIOS selection engine, or portions thereof, are illustratively implemented for use by tenants of such a multi-tenant environment.

Cloud infrastructure as disclosed herein can include cloud-based systems such as AWS, GCP and Microsoft Azure. Virtual machines provided in such systems can be used to implement at least portions of a cloud-based alternate BIOS selection platform in illustrative embodiments. The cloud-based systems can include object stores such as Amazon S3, GCP Cloud Storage, and Microsoft Azure Blob Storage.

In some embodiments, the cloud infrastructure additionally or alternatively comprises a plurality of containers implemented using container host devices. For example, a given container of cloud infrastructure illustratively comprises a Docker container or other type of Linux Container (LXC). The containers may run on virtual machines in a multi-tenant environment, although other arrangements are possible. The containers may be utilized to implement a variety of different types of functionality within the storage devices. For example, containers can be used to implement respective processing devices providing compute services of a cloud-based system. Again, containers may be used in combination with other virtualization infrastructure such as virtual machines implemented using a hypervisor.

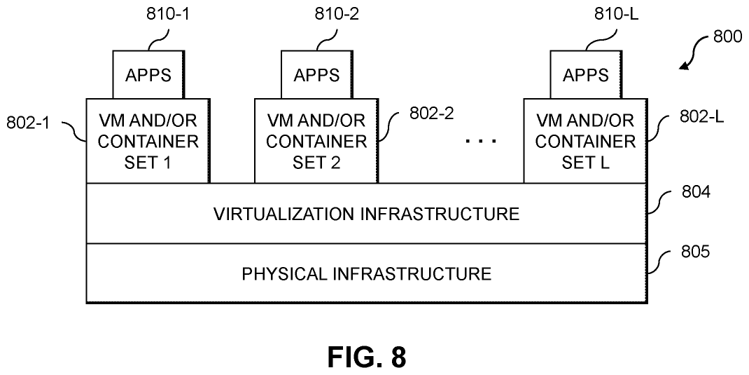

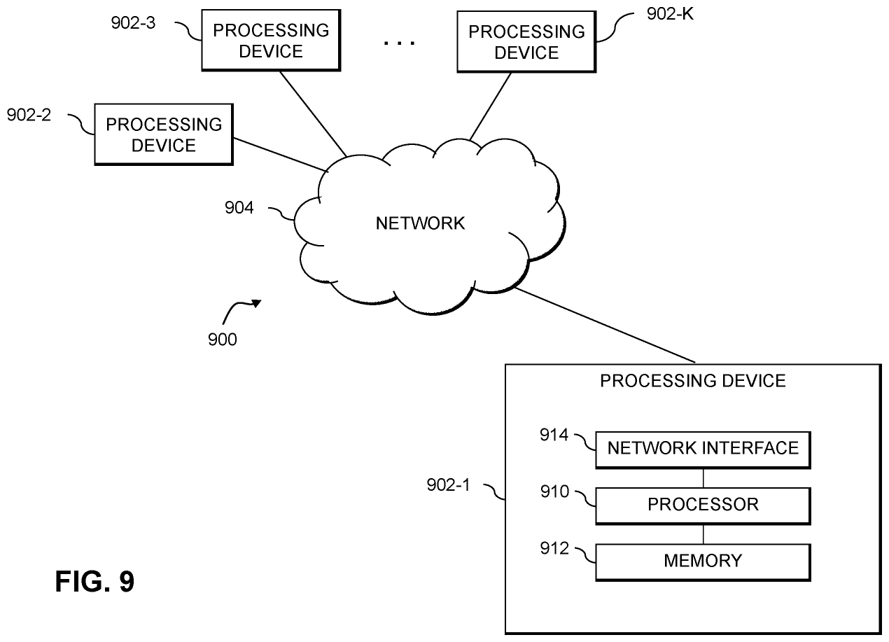

Illustrative embodiments of processing platforms will now be described in greater detail with reference to FIGS. 8 and 9. These platforms may also be used to implement at least portions of other information processing systems in other embodiments.

FIG. 8 shows an example processing platform comprising cloud infrastructure 800. The cloud infrastructure 800 comprises a combination of physical and virtual processing resources that may be utilized to implement at least a portion of the information processing system 100. The cloud infrastructure 800 comprises multiple virtual machines (VMs) and/or container sets 802-1, 802-2, . . . 802-L implemented using virtualization infrastructure 804. The virtualization infrastructure 804 runs on physical infrastructure 805, and illustratively comprises one or more hypervisors and/or operating system level virtualization infrastructure. The operating system level virtualization infrastructure illustratively comprises kernel control groups of a Linux operating system or other type of operating system.

The cloud infrastructure 800 further comprises sets of applications 810-1, 810-2, . . . 810-L running on respective ones of the VMs/container sets 802-1, 802-2, . . . 802-L under the control of the virtualization infrastructure 804. The VMs/container sets 802 may comprise respective VMs, respective sets of one or more containers, or respective sets of one or more containers running in VMs.

In some implementations of the FIG. 8 embodiment, the VMs/container sets 802 comprise respective VMs implemented using virtualization infrastructure 804 that comprises at least one hypervisor. Such implementations can provide alternate BIOS selection functionality of the type described above for one or more processes running on a given one of the VMs. For example, each of the VMs can implement alternate BIOS selection control logic and associated BIOS restoration functionality for one or more processes running on that particular VM.

An example of a hypervisor platform that may be used to implement a hypervisor within the virtualization infrastructure 804 is the VMware® vSphere® which may have an associated virtual infrastructure management system such as the VMware® vCenter™. The underlying physical machines may comprise one or more distributed processing platforms that include one or more storage systems.

In other implementations of the FIG. 8 embodiment, the VMs/container sets 802 comprise respective containers implemented using virtualization infrastructure 804 that provides operating system level virtualization functionality, such as support for Docker containers running on bare metal hosts, or Docker containers running on VMs. The containers are illustratively implemented using respective kernel control groups of the operating system. Such implementations can provide alternate BIOS selection functionality of the type described above for one or more processes running on different ones of the containers. For example, a container host device supporting multiple containers of one or more container sets can implement one or more instances of alternate BIOS selection control logic and associated BIOS restoration functionality.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 800 shown in FIG. 8 may represent at least a portion of one processing platform. Another example of such a processing platform is processing platform 900 shown in FIG. 9.

The processing platform 900 in this embodiment comprises at least a portion of the given system and includes a plurality of processing devices, denoted 902-1, 902-2, 902-3, . . . 902-K, which communicate with one another over a network 904. The network 904 may comprise any type of network, such as a WAN, a LAN, a satellite network, a telephone or cable network, a cellular network, a wireless network such as WiFi or WiMAX, or various portions or combinations of these and other types of networks.

The processing device 902-1 in the processing platform 900 comprises a processor 910 coupled to a memory 912. The processor 910 may comprise a microprocessor, a microcontroller, an ASIC, an FPGA or other type of processing circuitry, as well as portions or combinations of such circuitry elements, and the memory 912, which may be viewed as an example of a “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 902-1 is network interface circuitry 914, which is used to interface the processing device with the network 904 and other system components, and may comprise conventional transceivers.

The other processing devices 902 of the processing platform 900 are assumed to be configured in a manner similar to that shown for processing device 902-1 in the figure.

Again, the particular processing platform 900 shown in the figure is presented by way of example only, and the given system may include additional or alternative processing platforms, as well as numerous distinct processing platforms in any combination, with each such platform comprising one or more computers, storage devices or other processing devices.

Multiple elements of an information processing system may be collectively implemented on a common processing platform of the type shown in FIG. 8 or 9, or each such element may be implemented on a separate processing platform.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage devices or other components are possible in the information processing system. Such components can communicate with other elements of the information processing system over any type of network or other communication media.

As indicated previously, components of an information processing system as disclosed herein can be implemented at least in part in the form of one or more software programs stored in memory and executed by a processor of a processing device. For example, at least portions of the functionality shown in one or more of the figures are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining, by at least one processing device, in response to an application of power to the at least one processing device, one or more instructions provided by a selected basic input/output system (BIOS) chip of a plurality of BIOS chips of the at least one processing device, wherein the selected BIOS chip is selected using a selector switch that provides a connection between the selected BIOS chip and one or more additional components; and
executing, by the at least one processing device, at least one of the one or more instructions to initiate a boot process of the at least one processing device;
wherein the method is performed by the at least one processing device, wherein the at least one processing device comprises a processor coupled to a memory.

2. The method of claim 1, wherein the selector switch selects only one of the plurality of BIOS chips at a given time.

3. The method of claim 1, wherein the selector switch comprises at least portions of each of a plurality of electrical paths between the selected BIOS chip and the one or more additional components.

4. The method of claim 3, wherein the plurality of electrical paths comprise at least portions of each of at least a receive path, a transmit path and a power path.

5. The method of claim 1, wherein the selector switch provides power to the selected BIOS chip.

6. The method of claim 1, wherein the selector switch is controlled by a user to select one of the plurality of BIOS chips.

7. The method of claim 1, wherein the plurality of BIOS chips comprises at least a primary BIOS chip and at least one secondary BIOS chip, and wherein, in response to one or more of a failure of the selected BIOS chip, a degradation of the selected BIOS chip and a detection of unauthorized software on the at least one processing device, the selector switch is controlled to select one of the at least one secondary BIOS chip.

8. The method of claim 7, wherein the selected at least one secondary BIOS chip loads an operating system associated with the at least one processing device following the one or more of the failure, the degradation and the detection of the unauthorized software.

9. An apparatus comprising:
at least one processing device comprising a processor coupled to a memory;
a plurality of basic input/output system (BIOS) chips; and
a selector switch positioned to select a selected one of the plurality of BIOS chips;
the at least one processing device being configured to implement the following steps:
obtaining, by the at least one processing device, in response to an application of power to the at least one processing device, one or more instructions provided by the selected BIOS chip, wherein the selected BIOS chip is selected using the selector switch that provides a connection between the selected BIOS chip and one or more additional components; and
executing, by the at least one processing device, at least one of the one or more instructions to initiate a boot process of the at least one processing device.

10. The apparatus of claim 9, wherein the selector switch selects only one of the plurality of BIOS chips at a given time.

11. The apparatus of claim 9, wherein the selector switch comprises at least portions of each of a plurality of electrical paths between the selected BIOS chip and the one or more additional components.

12. The apparatus of claim 9, wherein the selector switch provides power to the selected BIOS chip.

13. The apparatus of claim 9, wherein the selector switch is controlled by a user to select one of the plurality of BIOS chips.

14. The apparatus of claim 9, wherein the plurality of BIOS chips comprises at least a primary BIOS chip and at least one secondary BIOS chip, and wherein, in response to one or more of a failure of the selected BIOS chip, a degradation of the selected BIOS chip and a detection of unauthorized software on the at least one processing device, the selector switch is controlled to select one of the at least one secondary BIOS chip.

15. A non-transitory processor-readable storage medium having stored therein program code of one or more software programs, wherein the program code when executed by at least one processing device causes the at least one processing device to perform the following steps:
obtaining, by the at least one processing device, in response to an application of power to the at least one processing device, one or more instructions provided by a selected basic input/output system (BIOS) chip of a plurality of BIOS chips of the at least one processing device, wherein the selected BIOS chip is selected using a selector switch that provides a connection between the selected BIOS chip and one or more additional components; and
executing, by the at least one processing device, at least one of the one or more instructions to initiate a boot process of the at least one processing device.

16. The non-transitory processor-readable storage medium of claim 15, wherein the selector switch comprises at least portions of each of a plurality of electrical paths between the selected BIOS chip and the one or more additional components.

17. The non-transitory processor-readable storage medium of claim 15, wherein the selector switch provides power to the selected BIOS chip.

18. The non-transitory processor-readable storage medium of claim 15, wherein the selector switch is positioned by a user to select one of the plurality of BIOS chips.

19. The non-transitory processor-readable storage medium of claim 15, wherein the plurality of BIOS chips comprises at least a primary BIOS chip and at least one secondary BIOS chip, and wherein, in response to one or more of a failure of the selected BIOS chip, a degradation of the selected BIOS chip and a detection of unauthorized software on the at least one processing device, the selector switch is controlled to select one of the at least one secondary BIOS chip.

20. The non-transitory processor-readable storage medium of claim 19, wherein the selected at least one secondary BIOS chip loads an operating system associated with the at least one processing device following the one or more of the failure, the degradation and the detection of the unauthorized software.
